(19) United States
(12) Patent Application Publication
(10) Pub. No.: US 2002/0006075 A1
(43) Pub. Date: Jan. 17, 2002

(54) Tireless rotary mixer

(75) Inventors: John D. Ferris, Kent, WA (US); Steven J. Malloy, Auburn, WA (US); Darrin L. Johnson, Kent, WA (US); David M. Wardell, Kirkland, WA (US); Kevin L. Kirby, Seattle, WA (US)

Correspondence Address: R REAMS GOODLOE JR, 10725 SE 256TH STREET, SUITE 3, KENT, WA, 980316426

(73) Assignee: ASPHALT EQUIPOMENT & SERVICE COMPANY Washington Corporation

(21) Appl. No.: 09/823,080

(22) Filed: Mar. 29, 2001

Related U.S. Application Data
(60) Provisional application No. 60/192,970, filed on Mar. 29, 2000.

(51) Int. Cl. B28C 5/46

(52) U.S. Cl. 366/25; 366/63

(57) ABSTRACT

A tireless rotatable asphalt mixer. The mixer is provided with a rotatable tubular cylindrical section that is suspended along an axis of rotation at bearing mounts. The apparatus is allowed to expand by way of fixing one bearing mount and allowing the other mount to float with respect to longitudinal elongation resulting from thermal expansion. In the mixer, heated aggregate, liquid asphalt cement, and aggregate dust are mixed to produce an asphalt composition. The asphalt cement injection point is adjustable longitudinally along the centerline of the mixer, by way of replacement of an asphalt cement injection tube with a substitute injection tube of a different length. Further, multiple asphalt cements of different compositions may be introduced into the mixer by means of additional injection pipes at the inlet end of the mixer. Recycled Asphalt Pavement (“RAP”) may be added to the mixer with heated aggregate through the inlet chute. RAP is then heated in the mixer and combined with aggregate, asphalt cement, and aggregate dust, to provide desired asphaltic compositions. The mixer is driven at a desired rotary speed by use of any convenient drive means, such as an electrical motor, gear reducer, and or chain drive mechanism. The design avoids wear and tear of prior art tire type drive mechanisms for heated rotary drums.

This application claims the benefit under 35 U.S.C. Section 119(e) of prior U.S. Provisional Patent Application No. 60/192,970, filed Mar. 29, 2000, the disclosure of which is incorporated herein by this reference.

### TECHNICAL FIELD

This invention relates to drum mixers for asphalt plants. More specifically, the invention is directed to a novel, improved drum mixer in which the drum is not driven or supported by tire type drive mechanisms.

### BACKGROUND

Many types of process equipment designs have been provided or taught for the preparation of asphaltic compositions, often called HMA or “hot-mix” by those in the trade. However, the prior art designs utilized for achieving rotary motion in mixing drums have repeatedly been directed toward the use of double or single tire drive designs. Such designs have been inherently troublesome and are prone to need a lot of maintenance attention, particularly with respect to trunnion adjustments and with respect to limited tire life. This is undesirable, since the preparation of asphaltic compositions often occurs under extreme time and schedule pressures, due to the need for coordination of the application of such compositions with crew schedules, road closure schedules, and suitable weather conditions. Downtime for maintenance can quickly become a major cost concern in the projects which require reliable preparation of HMA; in some projects, damages resulting from schedule delays can carry heavy penalties. Consequently, there remains an as yet unresolved need in the HMA preparation business for provision of a rotary drum mixer (a) which have inherently trouble free rotary drive components, and (b) which allow contact between asphalt cement, aggregate dust, and aggregate under optimum conditions, with respect to product composition and air quality concerns.

### OBJECTS, ADVANTAGES, AND NOVEL FEATURES

A primary object of our invention is to provide a rotary drum mixer which has a reliable, tireless support or drive mechanism, and which is economical to operate.

Another object of the invention is to provide a rotary drum mixer that is supported from each end by a weight supporting shaft that is mounted on bearings for rotary motion, rather than using a conventional trunnion and drive tire arrangement.

In conjunction with the preceding object, an additional object of the present invention is to eliminate alignment and wear problems as are commonly experienced in conventional drum mixer designs, by providing a novel support and drive mechanism.

To achieve the just mentioned objectives, a novel feature and advantage of the present invention is that a separate thrust bearing is used to accommodate the thrust generated due to inclined mounting and heating during use; this is preferably accomplished by using one fixed pillow block bearing (non-expansion) and once sliding pillow block bearing (expansion) to accommodate movement of the rotary drum dryer during use.

Another object of the invention is to provide a rotary drum mixer that allows contact between heated aggregate, asphalt cements and aggregate dust under optimum conditions, to minimize or avoid air pollution or loss of product concerns.

An additional object of the invention is to provide a means for heating and mixing recycled asphalt pavement (“RAP”) with heated aggregate, asphalt cement, and aggregate dust.

A still further and additional object of the invention is to provide an apparatus and method for removing hydrocarbons generated by contact of asphalt cement with hot aggregate and routing the same to the heat source (burner) for combustion, in order to eliminate objectionable air pollution.

A still further and important additional object of the invention is to provide the capability of insulating 100% of the mixer shell over its entire length.

Other and further objects of the invention will be understood by those in the art by examination of the drawing in conjunction with this specification.

### BRIEF DESCRIPTION OF THE DRAWING

In the description provided by the drawing, like reference numerals are employed to indicate like parts in the various figures, without the need for further mention thereof. The figures provided are as follows:

FIG. 1 is a partially broken side view of our novel asphalt plant drum mixer, constructed in accordance with the teachings herein, shown with aggregate inlet, first and second shaft portions supported for rotary motion by first and second supports via pillow block bearings, and also showing the motor, gear reducer, chain sprocket and final drive mechanism for effecting rotary motion of the mixer.

FIG. 2 is an end elevational view of the feed end of the drum mixer, showing the aggregate in-feed hopper, the inlet pipe for the asphaltic cement, the inlet pipe for aggregate dust, and additional asphalt cement inlets.

FIG. 3 is an end elevation view of the outlet end of the rotary drum mixer, showing the HMA discharge chute, the drive motor and frame, the chain and sprocket drive, and the support for the pillow block bearing on which a first shaft portion is mounted.

FIG. 4 is a cross-sectional view, taken across section line 4-4 of FIG. 1, showing the internal support bracing or “spider” for internal support of shaft portions about which the rotary drum mixer is rotated.

FIG. 5 is an end view of the rotary mixer just set forth above, now showing the unique rotary elbow which provides an effectively sealed conduit from a stationary asphalt source, such as through the flexible hose shown, to the internal rotating asphalt outlet pipe.

FIG. 6 is a side view of the rotary mixer and rotary elbow just illustrated in FIG. 5, showing how the rotary elbow is affixed to and effectively sealed with respect to the rotating asphalt outlet pipe.

### DETAILED DESCRIPTION

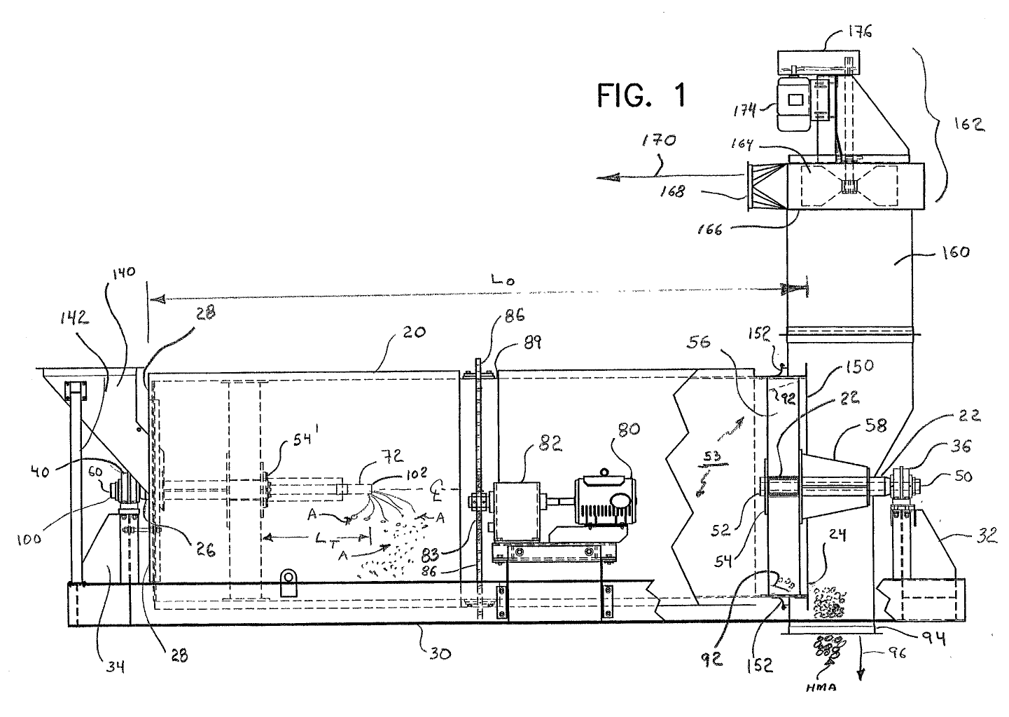

Attention is now directed to FIG. 1 of the drawing in which a cylindrical drum 20 is shown oriented along an axis of rotation, designated by the dashed line marked with “C_{L}” as indicated along the centerline of the drum 20, between a first shaft portion 22 at first end 24, and a second shaft portion 26 at second end 28. The cylindrical drum 20 is mounted above base support frame 30 by first structural support 32 at the first end 24, and by a second structural support 34 at second end 28. A first bearing 36, preferably but not necessarily of the pillow block type, is mounted on first structural support 32 for rotary support of first shaft portion 22, which is affixed to first end 24 of drum 20. A second bearing 40, preferably but not necessarily of the pillow block type, is mounted on second structural support 34 for rotary support of second shaft portion 26, which is affixed to second end 28 of drum 20.

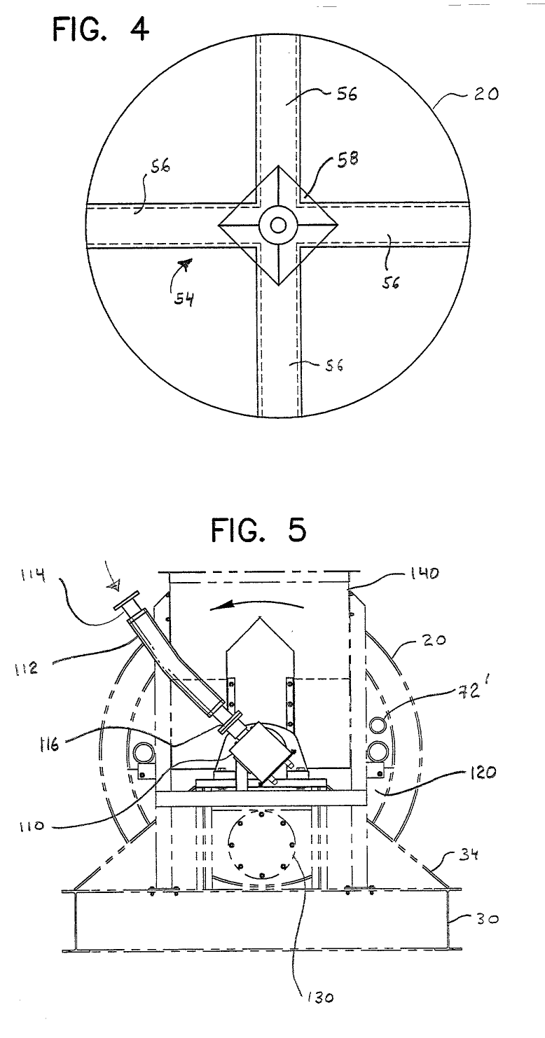

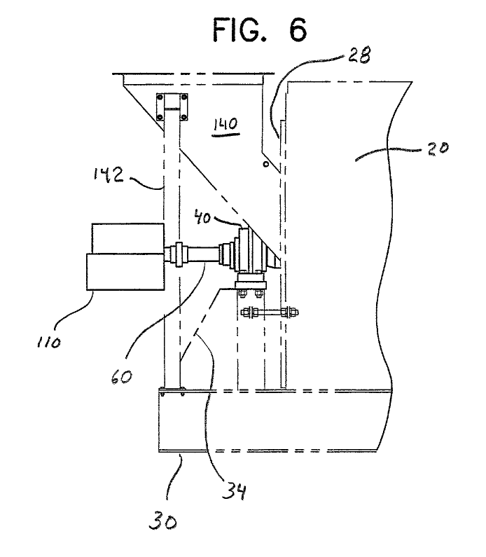

First shaft portion 22 includes an outer end 50 that is mounted in bearing 36, and an interior end 52 that protrudes into the interior 53 of drum 20 and which is supported by a structural steel spider 54 of the general design indicated in FIG. 4. Ideally, as seen in FIG. 4, the spider 54 design includes a pair of cross braces 56 extending outward to the periphery of drum 20, and a strengthening frame brace 58.

Second shaft portion includes an outer end 60 that is mounted in bearing 40, and an interior end 62 that is mounted in and which is supported by a second structural steel spider 54′ of the general design indicated in FIG. 4. The second shaft portion 60 is hollow, and at the distal, exterior end 62, a flange 70 is provided for affixing an outlet pipe 72 of variable length L.

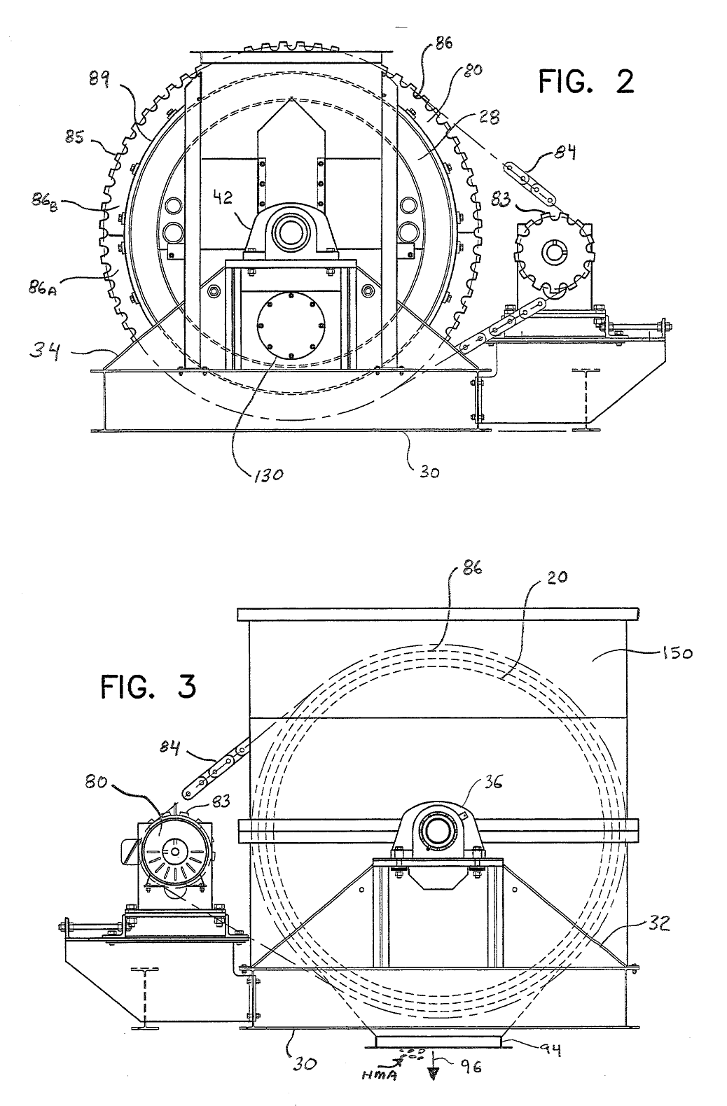

The mixer 20 is driven via a non-weight supporting driver mechanism, such as via electric motor 80, which acts through an appropriate gear reducer 82, to turn drive toothed sprocket 83 and thus energize a linked chain 84 or other suitable linkage for driving a thrust purchase mechanism on drum 20 such as toothed 85 drum sprocket 86. It should be recognized that sprocket 86 may be advantageously affixed to the outer surface or shell 89 of drum 20 via use of aligned, segmented portions, such as 86_{A} and 86_{B} as shown in FIG. 2.

Hot air is brought into the mixer drum 20 through the inlet chute 140 (further described below), and travels through the drum 20, for discharge out the air outlet duct 160 and thence to the exhaust fan 162.

At the outlet end 90, optional internal paddles 92 scoop the hot-mix asphalt (HMA) outward and thence downward through discharge chute 94, in the direction of reference arrow 96. When, as is illustrated in FIGS. 1 and 3, the discharge chute 94 is centered, paddles 92 may be omitted; however, when the discharge chute 94 is located off-center, then such paddles 92 are desirable for transfer of the finished product to the discharge chute 94.

Returning now to FIG. 1, the rotary mixer is provided with at least one asphaltic inlet tube 72 having an in-mixer length L_{T}, and where in said length L_{T} is less than the L_{O} of said mixer drum 20. Ideally, as shown in FIG. 1, the asphaltic inlet tube 72 is provided, at least in part, concentrically within the first support shaft portion 26. Further, it can be seen that the asphaltic inlet tube 72 has an inlet end 100 and an outlet end 102. As shown in FIG. 5, the inlet end 100 of asphaltic inlet tube 72 is sealingly mounted to a stationary rotary elbow 110. A flexible inlet hose 112, having an inlet end 114 and an outlet end 116 at the stationary rotary elbow 110 is used to provide an asphaltic composition A (see FIG. 1) to an interior space 53 in said rotary drum 20.

As also seen in FIG. 5, the mixer drum 20 ideally has a stationary first or inlet end wall portion 120. At this stationary end wall portion, 120, additional, such as second 122 or more asphaltic inlet tubes 72′ can be provided. 20. Also, an inspection manhole 130 can be provided to allow access, through the stationary inlet wall 120, to the interior space 52 within the rotatable mixer drum 20.

Also seen in FIGS. 1 and 5 is an inlet chute 140. The inlet chute 140 is provided with a support 142. The inlet chute 140 is hopper shaped for receiving incoming material such as aggregate or RAP, and directing the same to said interior space 53 within said rotatable drum 20.

The rotary drum 20 also normally utilizes a stationary second our outlet end wall 150. A seal 152 is provided between the rotatable drum 20 and the stationary discharge end 150. Also at the discharge end of the rotary drum 20, an outlet air duct 160 is provided sealingly affixed to the discharge end 150 of the rotatable drum 20. An induced draft fan 162 is provided, having an impeller portion 164, an impeller housing 166, and an air discharge plenum 168. The fan 162 is configured to pull air hot and commingled hydrocarbon contaminated gases outward in the direction of reference arrow 170, i.e., through said outlet air duct 160 and discharge such gases outward through said air discharge plenum 168. A motor 174, preferably electric drive type, is provided to drive fan 162 impellers 164 via gear or pulley drive mechanism 176.

During operation, it is to be appreciated that due to thermal effects, the overall length L_{O} will change due to thermal expansion on heating, and thermal contraction on cooling. To accommodate this effect, the first bearing 40 is preferably fixedly mounted to the first support shaft portion 60, so that the first support shaft 60 cannot move longitudinally with respect to the first bearing 40. However, the second bearing 36 is mounted in a manner which allows the second support shaft portion 50 to expand or contract, longitudinally along the centerline C_{L} of the mixer drum 20, with respect to the location of the second bearing 36. While it is preferred to use pillow block type bearings for bearings 36 and 40, other types may be utilized and accomplish the same design feature.

Overall, it is to be appreciated that our unique rotary drum mixer has an inlet end for receiving aggregate or RAP, or other suitable materials, an asphaltic cement injection line, a drive means for effecting rotary motion of the rotary drum 20, usually utilizing a mechanical drive linkage. Importantly, support means such as first and second shaft portions are provided, with extensions into the interior or the drum 20 as necessary to effect adequate structural support. Finally, bearing means are provided to rotationally support the first shaft portion and the second shaft portion.

In summary, it is clear from the foregoing description that a unique asphalt plant rotary mixer is provided. Operationally, the preferably tubular cylinder shaped drum is affixed to shaft portions that are supported at bearing mounts to suspend the drum along an axis of rotation. Each of the opposing shaft end portions are structurally supported at their respective first or second ends of the mixer drum by internal bracing within the mixer, such as with an “X” or “spider” cross-bracing structural support. The drum mixer is driven at a desired rotary speed by use of any convenient drive means, such as an electrical motor, gear driver and reducer, and/or gear drive with sprocket and chain drive mechanism. Overall, the drum and shaft portions of the apparatus are allowed to thermally expand by way of fixing one bearing mount and allowing the other mount to float, in order to accommodate the longitudinal elongation resulting from such thermal expansion. In the mixer, heated aggregate, liquid asphalt cement, and aggregate dust are mixed at about 300° F. or more to produce an asphalt composition. The asphalt cement injection point is adjustable longitudinally along the centerline of the mixer drum, by way of replacement of an asphalt cement injection tube with a substitute tube of different length. Further, multiple asphalt cements of different compositions may be introduced into the mixer by means of additional injection pipes located at the inlet end of the drum mixer. Importantly, Recycled Asphalt Pavement (“RAP”) may be added to the drum mixer along with heated aggregate, through the inlet chute. at the inlet end of the drum mixer. In such cases, the RAP is then heated in the mixer and combined with aggregate, asphalt cement, and aggregate dust, to provide a desired asphaltic composition. Optionally, a plurality of paddles at the discharge end are utilized to urge the asphaltic composition into a discharge chute, particularly chutes which are not centered below the mixer from which prepared asphaltic material is provided. In order to collect the residual hydrocarbons that are generated by the contact of asphaltic cement with heated aggregate, the plant is provided with an outlet air duct and a motor driven, preferably induced draft exhaust fan, having an air discharge plenum that routes contaminated air to a burner (not shown), in order to eliminate objectionable air pollution.

From the foregoing it will be seen that this invention provides an exemplary drive and support mechanism which avoids the use of tires and trunnions. Importantly, the design provided herein avoids wear and tear of prior art tire-type drive mechanisms for heated rotary drums. It is to be understood that various features and subcombinations within the teachings of this disclosure may be utilized and still remain within the scope and meaning of the claims of the invention as taught herein.

It is to be appreciated that the tireless drive system for rotary asphaltic mixers is an appreciable improvement in the art of asphalt equipment. Our novel design addresses the problem of how to avoid additional operational and maintenance costs of conventional drive mechanisms, while minimizing the complexity of an alternative drive mechanism, to provide a significantly improved rotary mixer system. Although only a few exemplary embodiments of this invention have been described in detail, it will be readily apparent to those skilled in the art that our tireless rotary asphaltic mixer may be modified from those embodiments provided herein, without materially departing from the novel teachings and advantages provided.

It will thus be seen that the objects set forth above, including those made apparent from the preceding description, are efficiently attained. Since certain changes may be made in designing the described structures when placing such structures into mass production, it is to be understood that my invention may be embodied in other specific forms without departing from the spirit or essential characteristics thereof. Many other embodiments are also feasible to attain advantageous results utilizing the is principles disclosed herein. Therefore, it will be understood that the foregoing description of representative embodiments of the invention have been presented only for purposes of illustration and for providing an understanding of the invention, and it is not intended to be exhaustive or restrictive, or to limit the invention only to the precise embodiments disclosed. The intention is to cover all modifications, equivalents, and alternatives falling within the scope and spirit of the invention, as expressed herein, in the various figures of the drawing, and in the appended claims. As such, it is intended to cover the methods, apparatus, structures, and the equivalent methods or structural equivalents thereof. The scope of the invention, as described herein is thus intended to include variations from the embodiments provided which are nevertheless described by the broad meaning and range properly afforded to the language herein, as explained by and in light of the terms included herein, or the legal equivalents thereof.

1. A rotary drum mixer for manufacturing an asphaltic composition, comprising:
(a) a rotatable drum having an inlet end, a discharge end, an outer surface, and an interior space;
(b) a first support shaft portion and a second support shaft portion, said first support shaft portion and said second support shaft portion respectively, mounted longitudinally to said rotatable drum along a central axis of rotation of said rotatable drum;
(c) first and second bearings each mounted externally to said rotatable drum to rotationally support said first support shaft portion and said second support shaft portion and therewith to rotationally support said rotatable drum;
(d) a thrust purchase mechanism mounted externally on said rotatable drum; a non-weight supporting drum driver, said drum driver operably connected to said thrust purchase mechanism for effecting rotary motion of said rotatable drum.

2. The apparatus as set forth in claim 1, wherein said thrust purchase mechanism on mounted on said rotary mixer comprises a toothed sprocket.

3. The apparatus as set forth in claim 2, wherein said toothed sprocket comprises a plurality of sprocket segments, and wherein said segments are aligned and mounted on said rotary mixer.

4. The apparatus as set forth in claim 2, wherein said drum driver comprises an outlet shaft and a toothed sprocket, and wherein said operable connection between said drum driver and said thrust purchase mechanism comprises a linked chain.

5. The apparatus as set forth in claim 1, further comprising at least one asphaltic inlet tube having an in-mixer length L_{T}, and where in said length L_{T} is less than the L_{O} of said mixer drum.

6. The apparatus as set forth in claim 5, wherein said asphaltic inlet tube is provided, at least in part, concentrically within said first support shaft portion.

7. The apparatus as set forth in claim 6, wherein said asphaltic inlet tube has an inlet end and an outlet end, and wherein said inlet end is sealingly mounted to a stationary rotary elbow.

8. The apparatus as set forth in claim 7, further comprising a flexible inlet hose, said flexible inlet hose having an outlet end at said stationary rotary elbow, and wherein said asphaltic composition is provided to said stationary rotary elbow via said flexible inlet hose.

9. The apparatus as set forth in claim 5, wherein mixer further comprises a stationary first end wall portion.

10. The apparatus as set forth in claim 9, wherein said apparatus further comprises a second asphaltic inlet tube.

11. The apparatus as set forth in claim 1, further comprising an inlet chute, said inlet chute hopper shaped for receiving incoming material and directing the same to said interior space within said rotatable drum.

12. The apparatus as set forth in claim 1, wherein in said discharge end of said rotatable drum is stationary.

13. The apparatus as set forth in claim 12, further comprising a seal between said rotatable drum and said stationary discharge end.

14. The apparatus as set forth in claim 13, further comprising an outlet air duct, said outlet air duct sealingly affixed to said discharge end of said rotatable drum.

15. The apparatus as set forth in claim 14, further comprising an induced draft fan, said fan comprising an impeller portion, an impeller housing, and an air discharge plenum, said fan configured to pull air hot, hydrocarbon contaminated gases outward through said outlet air duct and discharge such gases outward through said air discharge plenum.

16. The apparatus as set forth in claim 15, wherein said fan further comprises a drive motor.

17. The apparatus as set forth in claim 1, wherein said first bearing is fixedly mounted to said first support shaft portion, so that said first support shaft cannot move longitudinally with respect to said first bearing.

18. The apparatus as set forth in claim 1, wherein said second bearing is mounted in a manner which allows said second support shaft portion to expand or contract, longitudinally along said centerline, with respect to the location of said second bearing.

19. The apparatus as set forth in claim 17 or in claim 18 wherein said bearing is a pillow block bearing.

20. The apparatus as set forth in claim 9, wherein said apparatus further comprises an inspection manhole, said manhole allowing access, through said stationary inlet wall, to said interior space of said rotatable mixer.

21. A rotary drum mixer for manufacturing an asphaltic composition, comprising:
(a) a rotatable cylindrical drum having an inlet end and a discharge end,
(b) a drive means for effecting rotary motion of said drum, said drive means comprising a mechanical drive linkage;
(c) support means for said drum, said support means extending into said drum, and supporting a first shaft portion and a second shaft portion longitudinally along a central axis of rotation;
(d) bearing means to rotationally support said first shaft portion and said second shaft portion.
